(19) United States
(12) Patent Application Publication
(10) Pub. No.: US 2004/0119727 A1
(43) Pub. Date: Jun. 24, 2004

(54) Extracting displayed numerical data from displayed documents received from communication networks, e.g. World Wide Web, and processing the extracted numerical data independent of the received document

(75) Inventors: Timothy Alan Dietz, Austin, TX (US); Walid Kobrosly, Round Rock, TX (US); Nadeem Malik, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/324,511

(22) Filed: Dec. 19, 2002

(51) Int. Cl. G09G 5/00

(52) U.S. Cl. 345/629; 715/503

(57) ABSTRACT

A unique Web document interface function that enables the interactive user to simply extract or copy numerical data from one or more in a sequence of accessed and received Web pages. This extracted numerical data may then be stored and numerically processed independent of the Web document, and without affecting the Web document. A transparent displayed layer is superimposed over the displayed received network document; the user is enabled to extract numerical displayed data, e.g. highlighted data into the superimposed layer which functions to designate the numerical data in said underlying displayed network document to be extracted; and an implementation is provided for copying numerical data into said superimposed layer, e.g. into a spreadsheet for further processing.

### TECHNICAL FIELD

The present invention relates to computer managed communication networks such as the World Wide Web (Web) and, particularly, to systems, processes and programs for making the interactive user display interface, i.e. GUI, to Web pages received from the Web more user friendly and easier to use with respect to numerical data in such displayed pages.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct hyperlinks between Web pages embedded in such Web pages. This even further exploded the use of the Internet or Web.

As a result of these changes, it seems as if virtually all aspects of human endeavor in the industrialized world require human-computer interfaces. These changes have made computer directed activities accessible to a substantial portion of the industrial world's population which, up to a few years ago, was computer-illiterate, or, at best, computer indifferent.

Consequently, developers of Web documents/pages are continually working to make the handling of Web pages as simple and user friendly as possible. Such simplification, of course, involves the interactive user interfaces to Web pages. At the present time, it is fairly easy and straight forward for a user to print a Web page under the control of any standard Web browser program. Likewise, current Web browser programs enable the user to request to have the Web page downloaded and saved in its HTML format so that users may subsequently request that the browser fetch and display the Web page in its hypertext format whereby the user may still use the page hyperlinks to access linked documents.

Among the many present or potential uses of our vast communication networks, such as the Web or Internet (the terms are used interchangeably herein), is development of economic and statistical data involving the organization, processing and manipulation of numerical data taken from a variety of received Web documents or pages resulting from Web searches. In past technology, the user was required to take desired numerical data out of the Web documents using a variety of standard cut and paste routines available from the respective operating systems and word processing systems available at the users' receiving network terminals. This could be relatively cumbersome and awkward for the many data processing novices using the Web for economic research documentation or comparison shopping.

### SUMMARY OF THE PRESENT INVENTION

The present invention is directed to a unique Web document interface function that enables the interactive user to simply extract or copy numerical data from one or more of a sequence of accessed and received Web pages. This extracted numerical data may then be stored and numerically processed independent of the Web document and without affecting the Web document.

Accordingly, the present invention provides for extracting and processing numerical data from the received document by the combination of means at a receiving display station for displaying the received network document, means for superimposing a transparent displayed layer over said displayed received network document, user interactive means enabling the entry of displayed data into said superimposed layer by designating numerical data in said underlying displayed network document, and means for copying said designated numerical data into said superimposed layer. The independently stored extracted numerical data is now available for further numerical processing without affecting the Web documents from which they were extracted.

The system is more specifically implemented by copying said designated numerical copy of said data into said superimposed layer at a position in the superimposed layer directly above the copied data. More particularly, highlighting in the superimposed layer is used for the designation of numerical data in the underlying document. The system of this invention is particularly effective in an application where a spreadsheet outline is integrated into and displayed within the superimposed transparent layer to thereby enable the copying of the highlighted numerical data directly into selected cells in the spreadsheet.

The system is more specifically implemented by Web browsing means at the receiving display station including the above means for displaying the received Web page, the means for superimposing a transparent displayed layer over said displayed received Web page, the user interactive means enabling the entry of displayed data into the superimposed layer by designating numerical data in the underlying displayed Web page, and the means for copying said designated numerical data into the superimposed layer. This browser may further include the means for displaying a spreadsheet outline in said superimposed transparent layer, and the means for enabling the copying of the designated numerical data into selected cells in the spreadsheet.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system that may be used in practicing the present invention;

FIG. 2 is a generalized diagrammatic view of a Web portion upon which the present invention may be implemented;

FIG. 3 is a diagrammatic view of a typical Web page displayed at a receiving display station;

FIG. 4 is the diagrammatic Web page view of FIG. 3, after a user has highlighted numerical data on the page;

FIG. 5 is the diagrammatic Web page view of FIG. 4 after a spreadsheet in the overlay transparent layer has been superimposed over the Web page to extract a first highlighted numerical data item into a first cell in the spreadsheet;

FIG. 6 is the diagrammatic Web page view of FIG. 4 after the spreadsheet in the overlay transparent layer has been superimposed over the Web page to extract a second highlighted numerical data item into a second cell in the spreadsheet;

FIG. 7 is a diagrammatic outline of the spreadsheet showing the entries in the first and second cells thereof;

FIG. 8 is an illustrative flowchart describing the setting up of the process of the present invention for extracting or copying of numerical data from one or more in a sequence of accessed and received Web pages;

FIG. 9 is a flowchart of an illustrative run of the process set up in FIG. 8; and

FIG. 10 is a diagrammatic Web page of statics with a section of the statistics highlighted and, thus, designated for extraction from the Web page.

### DETAILED DESCRIPTION OF THE PREFERRED EMBODIMENT

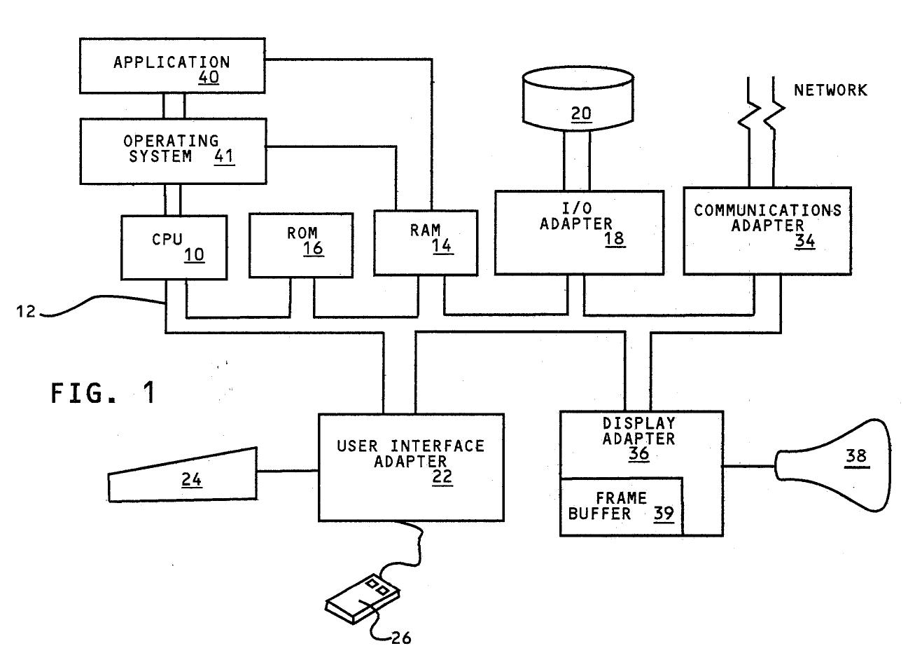

Referring to FIG. 1, a typical data processing terminal is shown that may function as the Web display stations used for receiving Web pages, for requesting Web searches and for Web browsing. A central processing unit (CPU) 10, such as one of the PC microprocessors or workstations, e.g. RISC System/6000™ series available from International Business Machines Corporation (IBM) or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; or Microsoft's WindowsXP™ or Windows2000™, or WindowsNT™, as well as other UNIX and AIX operating systems. Application programs 40, controlled by the system, are moved into and out of the main memory Random Access Memory (RAM) 14. These programs include the programs of the present invention for extracting and independently processing numerical data displayed in Web documents. These programs will be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference. Millennium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers. The invention may involve the use of search engines for searching. As described in the above-mentioned Internet: The Complete Reference, Millennium Edition text, pages 395 and 522-535, search engines use key words and phrases to query the Web for desired subject matter.

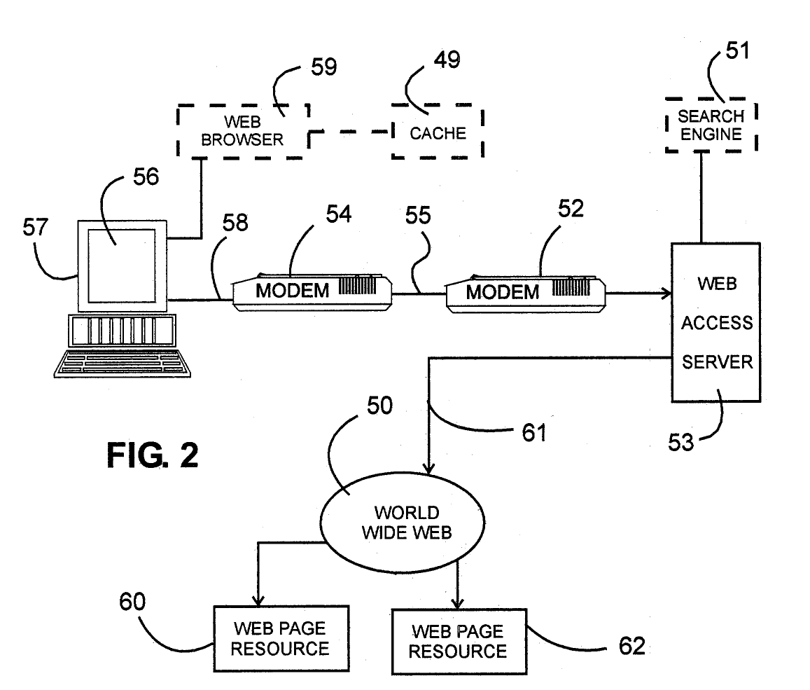

A generalized diagram of a portion of the Web, which the computer controlled display terminal 57 used for Web page receiving during searching or browsing, is connected as shown in FIG. 2. Computer display terminal 57 may be implemented by the computer system set up in FIG. 1 and connection 58 (FIG. 2) is the network connection shown in FIG. 1. For purposes of the present embodiment, computer 57 serves as a Web display station and has received displayed Web page 56, which is one of a sequence of Web pages containing text, graphics and embedded hyperlinks to other Web pages. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 that are linked 61 to the Web 50. The Web servers 53, which also may have the computer structure described with respect to FIG. 1, may be maintained by an ISP (Internet Service Provider) to the client's display terminal 57. The Web server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. The Web access server 53 uses one of the previously mentioned search engines 51 to access via the Web 50 the desired sequence of Web pages from appropriate Web resources, such as databases 60 and 62. Web server 53 will carry out the functions of obtaining the Web documents or pages as requested by the user via Web browser 59 and downloaded into storage in Web cache 49.

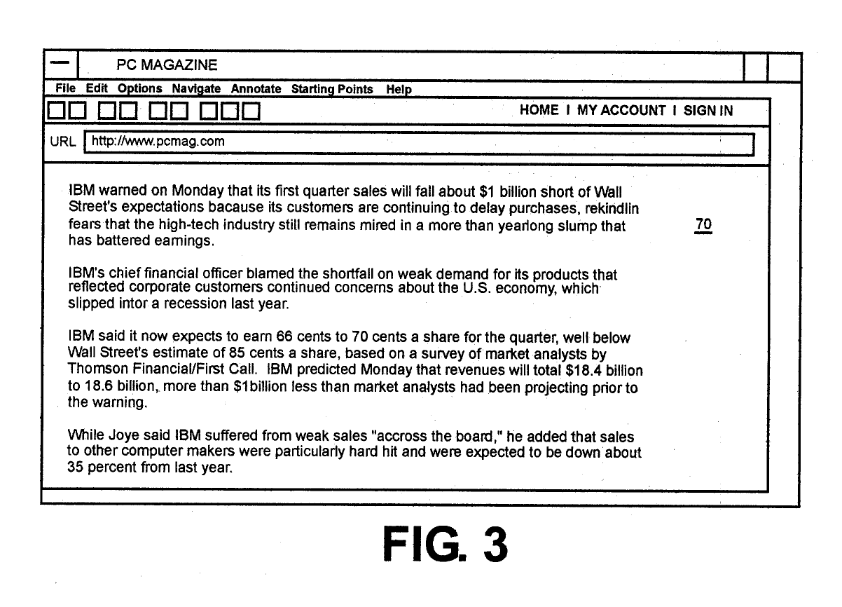

With this setup, the present invention, which will be described in greater detail with respect to FIGS. 3 through 7, may be carried out using Web browser 59 and associated Web server 53 (FIG. 2). Search engine 51 accesses the sequence of Web pages and provides such pages to the user at terminal 57 via Web browser 59 via server 53.

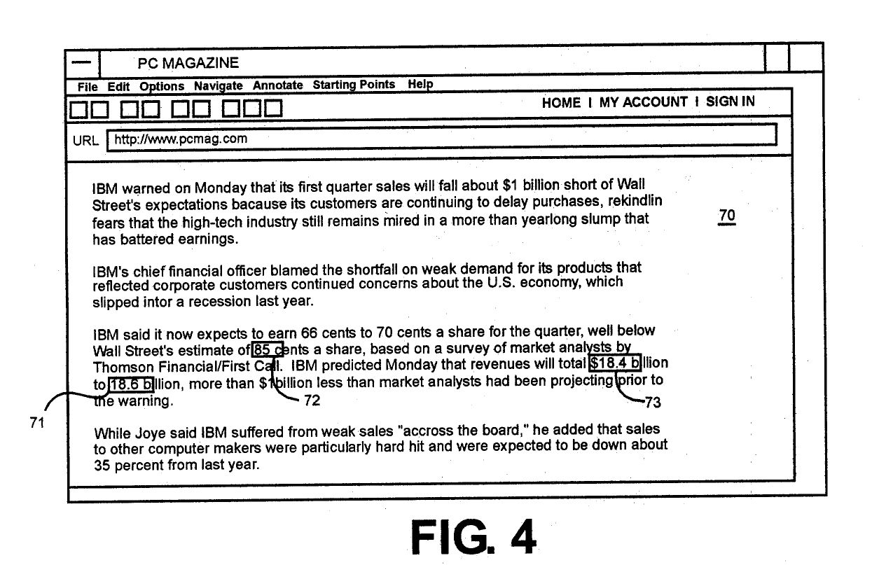

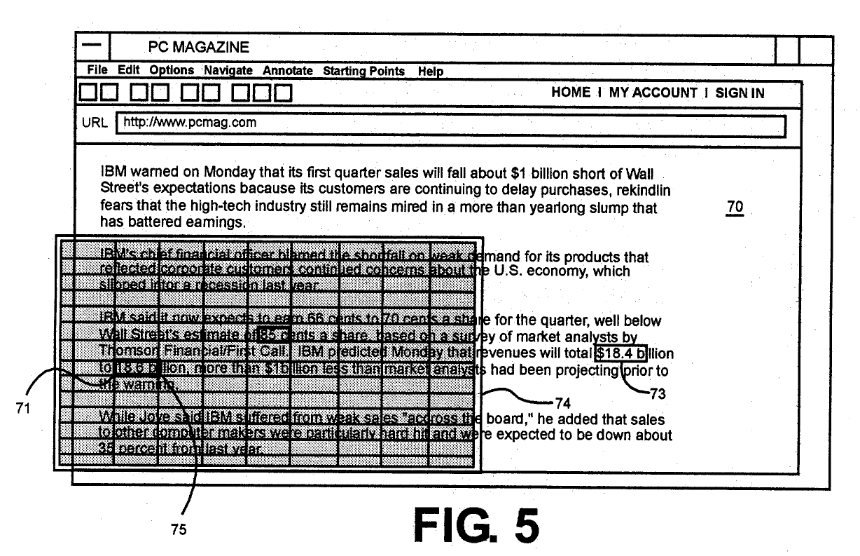

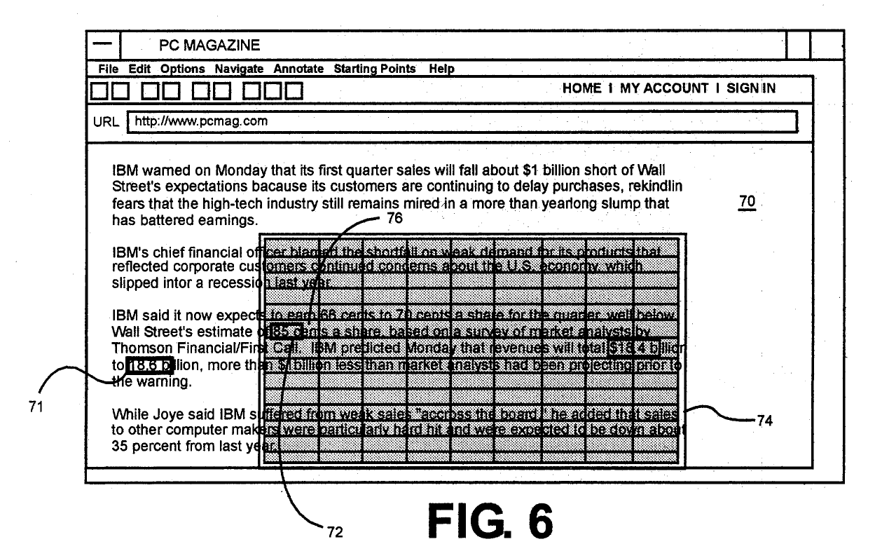

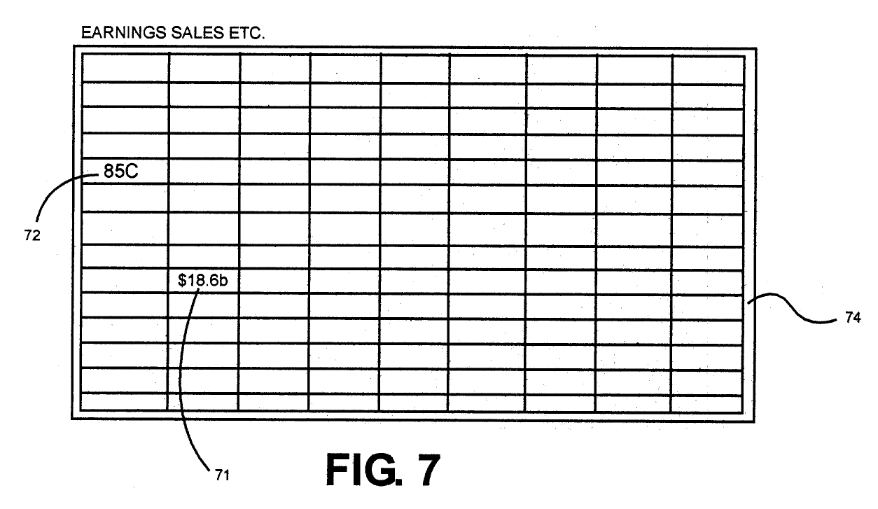

Now, with respect to FIGS. 3 through 7, we will give an illustrative example of how the present invention may be used to provide an implementation for extracting and independently processing numerical data displayed in Web documents. Web page 70, FIG. 3, is an illustration of the displayed Web page 56 in FIG. 2. This standard page may contain text, graphics and images, and hyperlinks to other Web documents. Using the basic text/graphics (GUI) editing function of the operating system, e.g. Windows 2000, or any conventional word processing program operable on the Windows OS, e.g. Word, WordPro or Word Perfect, the user may highlight, via conventional cursor/pointer routines, a plurality of numerical items 71, 72 and 73 in FIG. 4. This indicates that the user intends to extract or copy these items into a numerical processing layer as shown in FIG. 5. The Web browser at the receiving display station stores the data content of these highlighted numerical data items, as well as the positions of these items with respect to the overall Web page. The transparent outline image of a spreadsheet 74 that has been stored at the receiving display station under the control of the browser is displayed in a transparent layer overlaying the displayed Web page 70. To extract and, thus, copy numerical data from the Web page into the spreadsheet overlay 74, the spreadsheet is dragged using conventional cursor dragging until a highlighted numerical entry 71 coincides with the selected spreadsheet cell 75. The user by any suitable mouse clicking may enter numerical data 71 into the spreadsheet cell. The previously mentioned browser function of tracking the Web page locations of highlighted numerics aids in determining the coincidence of the numerical entries and the selected spreadsheet cells. Likewise, as illustrated in FIG. 6, spreadsheet overlay 74 is dragged or moved until numerical item 72 coincides with cell 76, and is consequently entered into the selected cell. The results of these two entries is shown in the illustration of the spreadsheet overlay shown in FIG. 7. It should be noted that for purposes of simplicity in illustration, the spreadsheet 74 has been shown as relatively empty. It will be understood that under normal operating conditions, the spreadsheet cells could be relatively full. When entered into the spreadsheet, the numerical data items copied from the Web page become integral parts of the spreadsheet, and, thus, may be subjected to all standard spreadsheet mathematical processing and editing without affecting the content of the Web page.

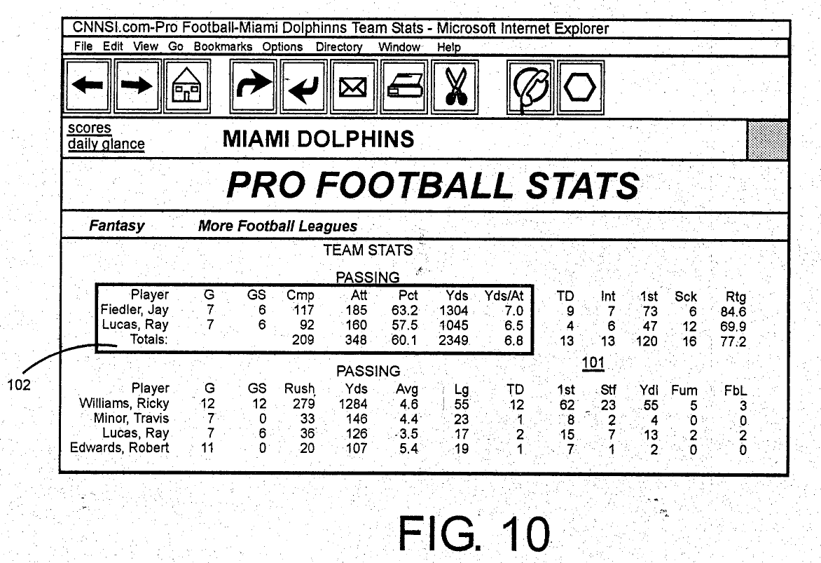

While FIGS. 4 to 7 describe the extraction of selected cells into the superimposed transparent layer cell by cell in a spreadsheet format, it should be understood that whole sections of formatted numerical tables may also be readily extracted. In FIG. 10, for example, the Web page 101 contains football statistics in tabular format. Using the techniques of the present invention, the user is enabled to highlight and, thus, designate a section 102 of the numerical statistical table to be extracted into the superimposed transparent layer.

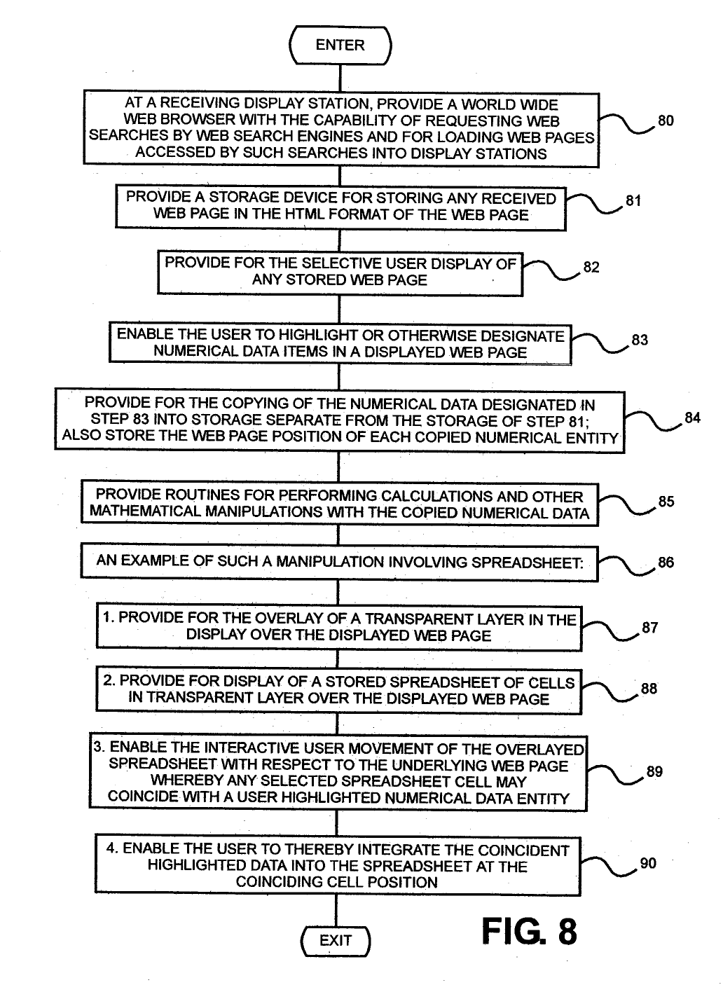

FIG. 8 is a flowchart showing the development of a process according to the present invention for extracting and independently processing numerical data displayed in Web documents. Most of the programming functions in the process of FIG. 8 have already been described in general with respect to FIGS. 3 through 7. A Web browser is provided at a receiving display station on the Web for accessing Web pages in the conventional manner and loading them at the display station, step 80. The Web pages are conventionally obtained via a Web server provided by an ISP. The Web browser has the capability of requesting searches from one or more search engines available through the Web. A conventional storage apparatus is provided for storing a received Web page in its HTML format, step 81. Provision is made for the user selecting to display a Web page as controlled by the Web browser, step 82. Provision is made to enable the user to selectively highlight or otherwise designate numerical data items in the displayed Web page, step 83. Provision is made for the copying of the highlighted numerical data into storage, step 84, separate from the storage of the Web document of step 81. The web page position of every copied numerical entry is also stored. Thus, routines may be provided for performing calculations and other mathematical manipulations on the copied numerical data, step 85.

A routine thus provided may involve a spreadsheet, step 86, with the following steps:

1. Provide for the overlay of a transparent layer in the display over the displayed Web page, step 87.

2. Provide for the display of a stored spreadsheet of cells in the transparent layer in the display over the displayed Web page, step 88.

3. Enable the interactive user movement of the overlayed spreadsheet with respect to the underlying Web page whereby any selected cell may be brought into coincidence with any highlighted numerical entry, step 89.

4. Enable the user to thereby integrate the coincident highlighted data into the spreadsheet at the coinciding cell position, step 90.

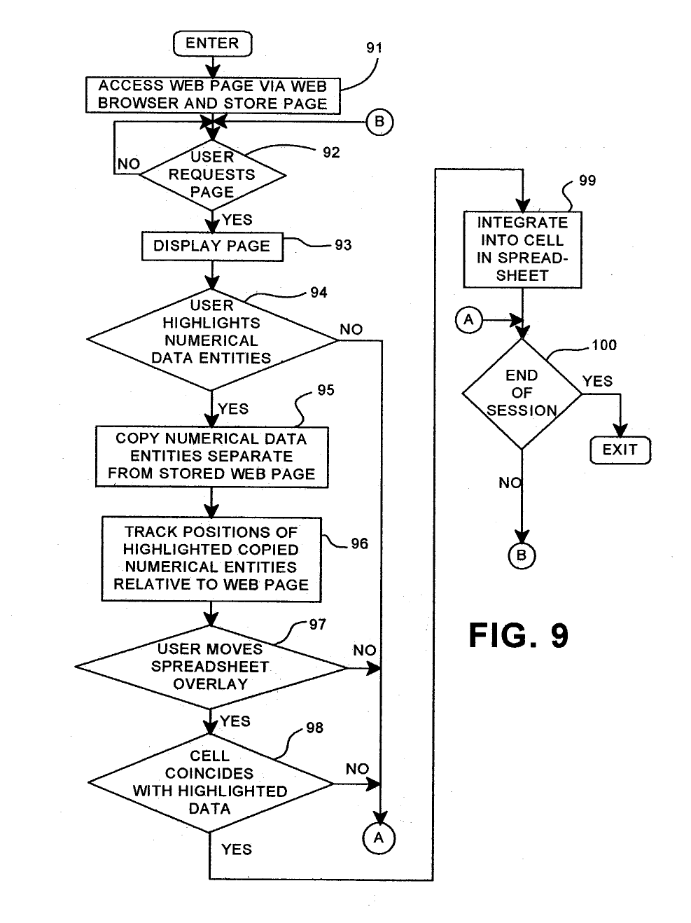

The running of the process set up in FIG. 8 and described in connection with FIGS. 3 through 7 will now be described with respect to the flowchart of FIG. 9. Let us assume that we are in a Web browsing session through the browser. The flowchart represents some steps in a routine that will illustrate the operation of the invention. The browser, via a Web access server, accesses the pages found by a search engine; the next Web page is accessed and stored in its HTML format in association with the browser, step 91. A determination is then made as to whether the user has requested the page, step 92. If No, such a request is awaited. If Yes, the page is displayed, step 93. During the display of this Web page, a determination is made as to whether the user has highlighted any numerical data items on the displayed Web page, step 94. If Yes, the browser copies and has stored the highlighted items separate from the Web page, step 95, and the positions of these highlighted copied entries relative to the displayed Web page are also stored, step 96. Then, a determination is made as to whether the user has brought up and is moving the spreadsheet overlay, step 97. If Yes, further determination is made as to whether there is a coincidence between a spreadsheet cell and a highlighted numerical data item, step 98. If Yes, and the user has thus clicked on the item for integration into the spreadsheet, then, step 99, the item is integrated into the spreadsheet at the selected cell where the numerical data becomes part of the spreadsheet for further processing. At this point, or if the determination in either of steps 94, 97 or 98 is No, then (via branch “A”), step 100, a determination may conveniently be made as to whether the session is over. If Yes, the session is exited. If No, the process is returned via branch “B” to step 92 and the session is continued.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a communication network with user access via a plurality of data processor controlled interactive receiving display stations for displaying received documents of at least one display page containing text and images, and available from sources on the network, a system for extracting and processing numerical data from the received document comprising:
means at a receiving display station for displaying the received network document;
means for superimposing a transparent displayed layer over said displayed received network document;
user interactive means enabling the entry of displayed data into said superimposed layer designating numerical data in said underlying displayed network document; and
means for copying said designated numerical data into said superimposed layer.

2. The communications network system of claim 1 further including user interactive means for processing said copied numerical data.

3. The communications network of claim 2 wherein said communications network is the World Wide Web (Web), and said network documents are Web pages.

4. The Web communications network of claim 3 wherein said means for copying said designated numerical copy of said data into said superimposed layer at a position in the superimposed layer directly above the copied data.

5. The Web communications network of claim 3 wherein said displayed data entered into said superimposed layer designating numerical data in said underlying document comprises highlighting.

6. The Web communications network of claim 5 further including means for displaying a spreadsheet outline in said superimposed transparent layer.

7. The Web communications network of claim 6 wherein said means for copying enable the copying of highlighted numerical data into selected cells in said spreadsheet.

8. The Web communications network of claim 3 further including Web browsing means at said receiving display station including:
said means for displaying the received Web page;
said means for superimposing a transparent displayed layer over said displayed received Web page;
said user interactive means enabling the entry of displayed data into said superimposed layer designating numerical data in said underlying displayed Web page; and
said means for copying said designated numerical data into said superimposed layer.

9. The Web communications network of claim 8 wherein:
said Web browser further includes means for displaying a spreadsheet outline in said superimposed transparent layer; and
said means for copying enable the copying of said designated numerical data into selected cells in said spreadsheet.

10. In a communication network with user access via a plurality of data processor controlled interactive receiving display stations for displaying received documents of at least one display page containing text and images, and available from sources on the network, a method for extracting and processing numerical data from the received document comprising:
displaying the received network document at a receiving display station;
superimposing a transparent displayed layer over said displayed received network document;
enabling the user interactive entry of displayed data into said superimposed layer designating numerical data in said underlying displayed network document; and
copying said designated numerical data into said superimposed layer.

11. The communications network method of claim 10 further including the step of interactively processing said copied numerical data.

12. The communications network method of claim 11 wherein said communications network is the Web, and said network documents are Web pages.

13. The method of claim 12 wherein said designated numerical data is copied into said superimposed layer at position in the superimposed layer directly above the copied numerical data.

14. The method of claim 12 wherein said displayed data entered into said superimposed layer designating numerical data in said underlying document comprises highlighting.

15. The method of claim 14 further including the step of displaying a spreadsheet outline in said superimposed transparent layer.

16. The method of claim 15 wherein said step of copying enables the copying of highlighted numerical data into selected cells in said spreadsheet.

17. The method of claim 12 further including a Web browsing process at said receiving display station including said steps of:
displaying the received Web page;
superimposing a transparent displayed layer over said displayed received Web page;
enabling said user interactive entry of displayed data into said superimposed layer designating numerical data in said underlying displayed Web page; and
said copying of said designated numerical data into said superimposed layer.

18. The method of claim 17 wherein:
said Web browser process further includes the steps of displaying a spreadsheet outline in said superimposed transparent layer; and
copying of said designated numerical data into selected cells in said spreadsheet.

19. A computer program having code recorded on a computer readable medium for extracting and processing numerical data from a document containing text and images received at a receiving display station from sources on a communication network with user access via a plurality of data processor controlled interactive receiving display stations, said computer program comprising:
means at a receiving display station for displaying the received network document;
means for superimposing a transparent displayed layer over said displayed received network document;
user interactive means enabling the entry of displayed data into said superimposed layer designating numerical data in said underlying displayed network document; and
means for copying said designated numerical data into said superimposed layer.

20. The computer program of claim 19 further including user interactive means for processing said copied numerical data.

21. The computer program of claim 20 wherein said communications network is the Web, and said network documents are Web pages.

22. The computer program of claim 21 wherein said means for copying said designated numerical copy said data into said superimposed layer at position in the superimposed layer directly above the copied data.

23. The computer program of claim 21 wherein said displayed data entered into said superimposed layer designating numerical data in said underlying document comprises highlighting.

24. The computer program of claim 23 further including means for displaying a spreadsheet outline in said superimposed transparent layer.

25. The computer program of claim 24 wherein said means for copying enable the copying of highlighted numerical data into selected cells in said spreadsheet.

26. The computer program of claim 21 further including a Web browser program at said receiving display station including:
said means for displaying the received Web page;
said means for superimposing a transparent displayed layer over said displayed received Web page;
said user interactive means enabling the entry of displayed data into said superimposed layer designating numerical data in said underlying displayed Web page; and
said means for copying said designated numerical data into said superimposed layer.

27. The computer program of claim 26 wherein:
said Web browser program further includes means for displaying a spreadsheet outline in said superimposed transparent layer; and
said means for copying enable the copying of said designated numerical data into selected cells in said spreadsheet.

28. In a communication network with user access via a plurality of data processor controlled interactive receiving display stations for displaying received documents of at least one display page containing text and images, and available from sources on the network, a system for extracting and processing numerical data from the received document comprising:
a receiving display station for displaying the received network document;
an implementation for superimposing a transparent displayed layer over said displayed received network document;
user interactive apparatus enabling the entry of displayed data into said superimposed layer designating numerical data in said underlying displayed network document; and
an implementation for copying said designated numerical data into said superimposed layer.

29. The communications network system of claim 28 further including a user interactive implementation for processing said copied numerical data.

30. The communications network of claim 29 wherein said communications network is the Web, and said network documents are Web pages.

31. The Web communications network of claim 30 wherein said implementation for copying said designated numerical copy of said data into said superimposed layer at a position in the superimposed layer directly above the copied data.

32. The Web communications network of claim 30 wherein said displayed data entered into said superimposed layer designating numerical data in said underlying document comprises highlighting.

33. The Web communications network of claim 32 further including an implementation for displaying a spreadsheet outline in said superimposed transparent layer.

34. The Web communications network of claim 33 wherein said implementation for copying enables the copying of highlighted numerical data into selected cells in said spreadsheet.
